(19) United States
(12) Patent Application Publication
(10) Pub. No.: US 2014/0359095 A1
(43) Pub. Date: Dec. 4, 2014

(54) METHOD AND APPARATUS FOR AUTOMATICALLY CREATING INSTANCES FROM A CONTROL SYSTEM TOPOLOGY

(71) Applicant: GE Intelligent Platforms, Inc., Charlottesville, VA (US)

(72) Inventors: Steven William Smith, Roanoke, VA (US); Michael Martin Franke, Salem, VA (US); Jack R. Kirby, Salem, VA (US)

(21) Appl. No.: 13/908,130

(22) Filed: Jun. 3, 2013

(51) Int. Cl. H04L 12/24

(52) U.S. Cl. CPC H04L 41/0806
USPC 709/222

(57) ABSTRACT

Approaches for automatically creating device type manager (DTM)-compliant instances in a Field Device Tool (FDT)-compliant network are presented. Network topology information is uploaded to a user. The network topology information concerns a plurality of devices of a known type connected in a network that is located in a predefined local area. The network topology information relates to one or more of an operation of the devices or an interconnection of the plurality of devices in the network. At least one DTM-compliant software instance that implements the network topology information is automatically created.

### CROSS REFERENCES TO RELATED APPLICATIONS

Utility application entitled “Method and Apparatus for Creating Instances for Predefined areas of a Topology” naming as inventors Steven Smith, Michael Franke, and Jack Kirby, and having attorney docket number 267539 (130874); and

Utility application entitled “Method and Apparatus to Present a Control System Topology” naming as inventors Steven Smith, Michael Franke, and Jack Kirby, and having attorney docket number 266359 (130875);

are being filed on the same day as the present application and are incorporated herein by reference in their entireties.

### BACKGROUND OF THE INVENTION

1. Field of the Invention

The present invention generally relates to control systems and, more specifically, to configuring control systems.

2. Brief Description of the Related Art

Field Device Tool (FDT) applications provide various types of interfaces between devices (e.g., valves, temperature sensors, and pressure sensors) and control systems. To implement the functions in these applications, Device Type Manager (DTM) modules are utilized. For example, a particular user may utilize DTM modules that open and close valves in a manufacturing plant.

DTM modules are typically software modules and used to configure or control the various pieces of equipment. These modules are programmed to send various uniform commands and to keep and display data in a predetermined way.

DTM instances have been created manually (without human intervention) in previous systems. This introduces human error, is slow, and costly. These problems, in turn, have resulted in user frustration with some previous approaches.

### BRIEF DESCRIPTION OF THE INVENTION

The present approaches automatically create instances of discovered remote devices based upon a system topology that is uploaded from a gateway. The approaches described herein are easy to implement and increase user satisfaction with system operation. Additionally, the element of human error is removed thereby enhancing system performance and further enhancing user satisfaction with these approaches.

In one aspect, a device manager gateway service provides a communication gateway between third party device management applications and remotely located devices in a control system. The device manager gateway provides a communication DTM that enables communication with FDT Frame Applications. The device manager gateway has knowledge of the system topology and provides this information to the communication DTM through a custom interface that is outside of the FDT specification. The communication DTM requests the system topology which is the list of the remotely located equipment modules and their module types under each controller. The communication DTM provides the capability to the user to automatically create instances of the discovered remotely located devices.

In some aspects, a custom interface between the device manager gateway and its associated communication DTM is used to automate the creation of the system topology in the FDT Frame Application, greatly reducing the amount of manual steps involved in configuring the system topology and eliminating the need for the user to know anything about the underlying system topology. The user simply adds the communication DTM to the FDT Frame Application, connects to the device manager gateway service running on the local or a remote personal computer (PC), uploads the topology, then instructs the communication DTM to add the appropriate Gateway DTM instances.

In many of these embodiments, network topology information is uploaded to a user. The network topology information concerns a plurality of devices of a known type connected in a network that is located in a predefined local area. The network topology information relates to one or more of an operation of the devices or the interconnection of the plurality of devices in the network. At least one DTM-compliant software instance that implements the network topology information is automatically created.

In some aspects, the user is allowed to select a subset of the topology and then at least one DTM-compliant software instance of the selected subset of the topology is automatically created. In other examples, the user is allowed to make a selection using a graphical display unit. The graphical display unit may be disposed on a device such as a personal computer, a lap top, a cellular phone and a personal digital assistant. Other examples are possible.

The predefined local area may be a manufacturing plant or a utility plant. Other examples of areas are possible. In other aspects, the uploading is performed by a gateway. In some other examples, the plurality of devices comprises a valve or switch.

In others of these embodiments, an apparatus that is configured to automatically create device type manager (DTM)-compliant instances in a Field Device Tool (FDT)-compliant network includes an communication DTM and a device manager gateway. The communication DTM is configured to receive uploaded network topology information from the device manager gateway. The network topology information concerns a plurality of devices of a known type connected in a network that is located in a predefined local area. The network topology information relates to one or more of an operation of the devices or the interconnection of the plurality of devices in the network.

The communication DTM is coupled to the device manager gateway. The communication DTM is configured to automatically create at least one DTM-compliant software instance that implements the network topology information.

### BRIEF DESCRIPTION OF THE DRAWINGS

FIG. 1A comprises a block diagram of a system for automatically adding DTM instances according to various embodiments of the present invention;

FIG. 1B comprises a block diagram of a system for automatically adding DTM instances according to various embodiments of the present invention;

FIG. 2 comprises a flow chart of an approach for automatically adding DTM instances according to various embodiments of the present invention; and

FIG. 3 comprises a block diagram of an apparatus for automatically adding DTM instances according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

In the present approaches, a device manager gateway has knowledge of the system topology and provides this information to its associated FDT communication DTM, removing the burden of knowing anything about the system topology from the user. A device manager gateway communication DTM uses the uploaded topology information to automatically create instances of the necessary gateway DTMs in the FDT Frame Application. The device manager gateway and its associated communication DTM provide the mechanism to automate the creation of the DTMs required to communicate with remotely located devices in order to save time and eliminate configuration errors.

In some aspects, the device manager gateway and its communication DTM push the system configuration to the FDT Frame Application rather than relying on the user to know the system topology and add the components manually (and correctly). This not only saves configuration time and eliminates configuration errors, but it also makes it very simple for a user with basic FDT knowledge to connect to a control system and gain access to any FDT based and remotely located devices in the system without any specific knowledge of the system. The device manager gateway and communication DTM allow the user to focus on interacting with the remotely located devices and not on the system topology.

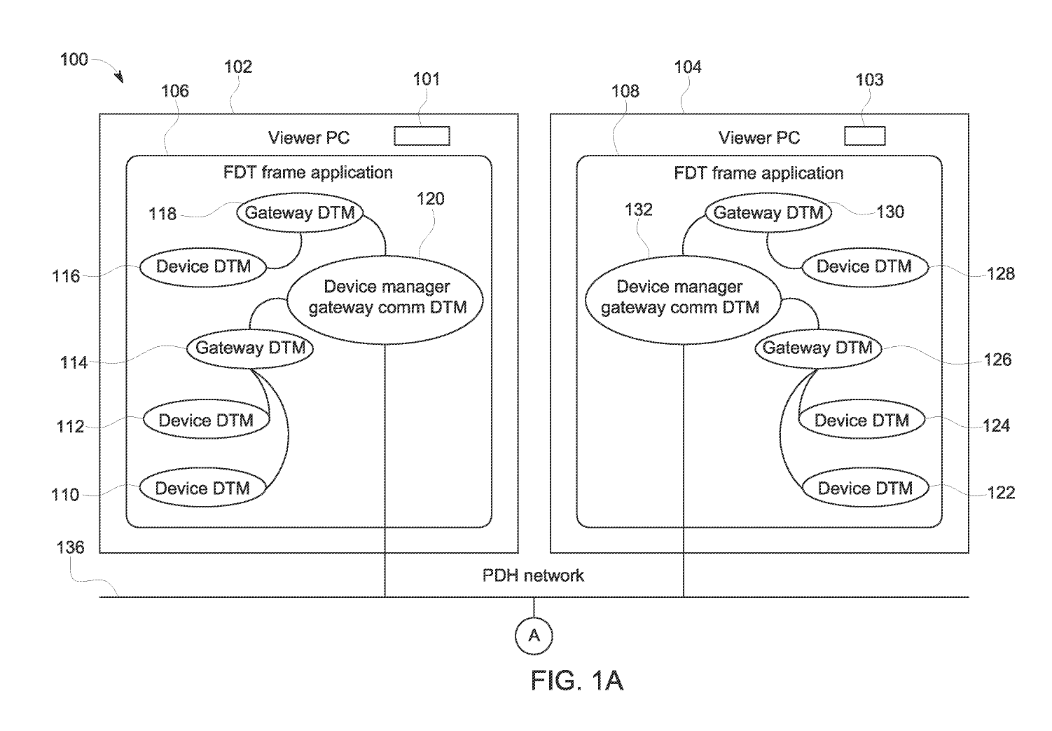

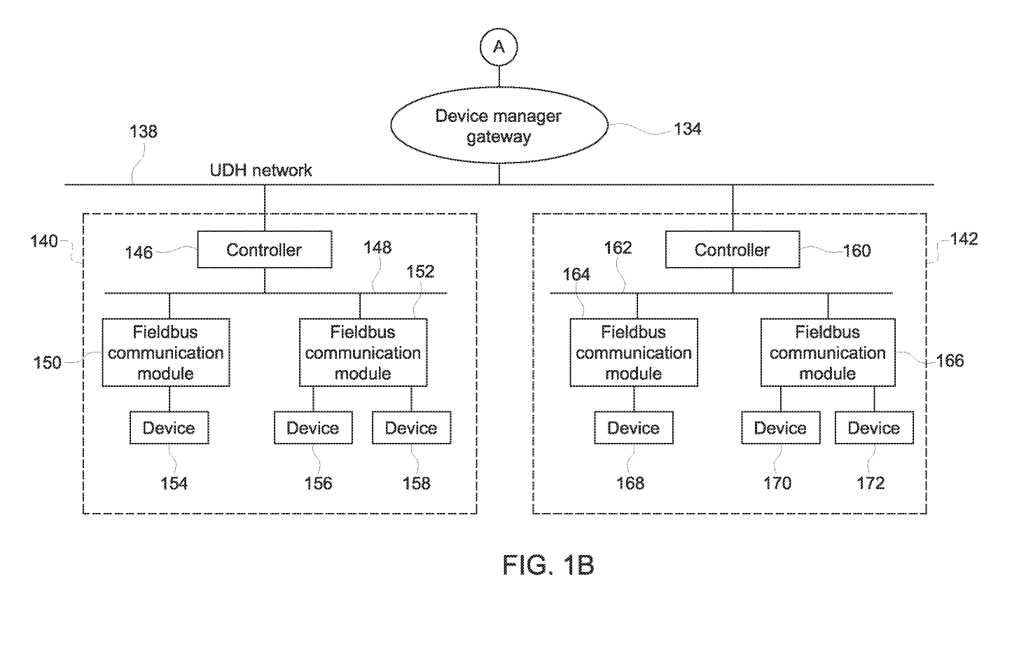

Referring now to FIG. 1A, one example of a system 100 that is configured to provide a control system topology to a communication DTM (or some other entity) is described. The system 100 includes a first viewer personal computer 102 and a second viewer personal computer 104. The first viewer personal computer 102 and the second viewer personal computer 104 are any type of user interface device such as a personal computer, laptop, cellular phone, personal digital assistant, or any other device having a processor, memory and that is capable of displaying information in any format to a user.

It will be appreciated that the modules and functions described herein can be implemented as programmed software operating on a general purpose programming device such as a microprocessor. However, any combination of computer hardware and/or programmed computer software may be utilized to implement these functions and modules.

The first viewer personal computer 102 includes a first FDT frame application 106. The first FDT frame application 106 includes a first gateway DTM 118, a second gateway DTM 114, a first device manager gateway communication DTM 120, a first device DTM module 116, a second device DTM module 112, and a third device DTM module 110. The second viewer personal computer 104 includes a second FDT frame application 108. The second FDT frame application 108 includes a third gateway DTM module 130, a fourth gateway DTM module 126, a second device manager gateway communication DTM module 132, a fourth device DTM module 128, a fifth device DTM module 124 and a sixth device DTM module 122.

A plant data highway (PDH) network 136 couples to a device manager gateway 134. The device manager gateway 134 couples to a first local network 140 and a second local network 142 via a unit data highway (UDH) network 138. The plant data highway (PDH) network 136 and unit data highway (UDH) network 138 operate according to established protocols as known to those skilled in the art and these will not be discussed further herein. Other examples and types of networks may also be used.

The first local network 140 includes a first controller 146 that is coupled to a first field bus communication module 150 and a second field bus communication module 152 via a local network 148. A first device 154 couples to the first field bus communication module 150. A second device 156 and a third device 158 couples to the second field bus communication module 152.

The second local network 142 includes a second controller 160 that is coupled to a third field bus communication module 164 and a fourth field bus communication module 166 via a local network 142. A fourth device 168 couples to the third field bus communication module 164. A fifth device 170 and a sixth device 172 couples to the fourth field bus communication module 166.

The device DTM modules 110, 112, 116, 122, 124, and 128 are software modules that know how to contact a particular piece of equipment 154, 156, 158, 168, 170, or 172. The modules 110, 112, 116, 122, 124, and 128 know the device's parameters and automatically include functionality to create messages to obtain or exchange information that are specific to a particular piece of equipment.

The gateway DTM 114 and the gateway DTM 118 are I/O modules that communicate with the DTM equipment module in native format and forward the messages/communications between the equipment modules and the Device manager gateway communication module 120 or 132.

The Device manager gateway communication DTM 120 and 132 make connections and exchange communications with the Device gateway manager at a remote location, e.g., a plant.

The first viewer personal computer 102 or the second viewer personal computer 104 shows the information in an appropriate format. This may be located at a personal computer to take one example.

The Device gateway manager 134 is located at a remote location, e.g., a plant. It knows the routing of messages to and from the particular pieces of equipment and which DTM to send the message to if received from the equipment. The controllers 146 and 160 pass messages to the field bus communications modules 150, 152, 164, and 166 and may be implemented as processors executing programmed computer software.

The field bus communication module 150, 152, 164, and 166 provides input/output (i/o) functions (e.g., transmitting and receiving information) with respect to the equipment or devices 154, 156, 158, 168, 170, and 172. The equipment 154, 156, 158, 168, 170, and 172 may be valves or sensors to mention two examples. Other examples of equipment may also be used.

In one example of the operation of the system of FIG. 1B network topology information is uploaded to a user. The network topology information concerns a plurality of devices of a known type connected in a network that is located in a predefined local area and this may reside at the device manager gateway 134. The network topology information relates to one or more of an operation of the devices or an interconnection of the plurality of devices in the UDH network (e.g., the devices 154, 156, 158, 168, 170, and 172 and their interconnections).

At least one DTM-compliant software instance that implements the network topology information is automatically created. More specifically, the topology information is uploaded to the first device manager gateway communication DTM 120 and/or the second device manager gateway communication DTM 132. The information may be displayed on media 101 or 103. The first device manager gateway communication DTM 120 or the second device manager gateway communication DTM 132 (or some other appropriate module) determine if a device DTM module is missing, i.e., whether one of the device DTM modules 110, 112, 116, 122, 124, or 128 is associated with the equipment in the topology. If there is an association, no device DTM module need be created. If there is no association, then a new device DTM module is automatically created according to FDT frame application approaches. More specifically, the device's parameters are included in the new module as is its functionality (e.g., software instructions) to create messages to obtain or exchange information that is specific to a particular piece of equipment.

In some aspects, the user is allowed to select a subset of the topology (via the screens or graphical display units 101 or 103) and then at least one DTM-compliant software instance of the selected subset of the topology is created. The screens 101 or 103 may be disposed on a device such as a personal computer, a lap top, a cellular phone and a personal digital assistant. Other examples are possible.

The predefined local area may be a manufacturing plant or a utility plant. Other examples of areas are possible.

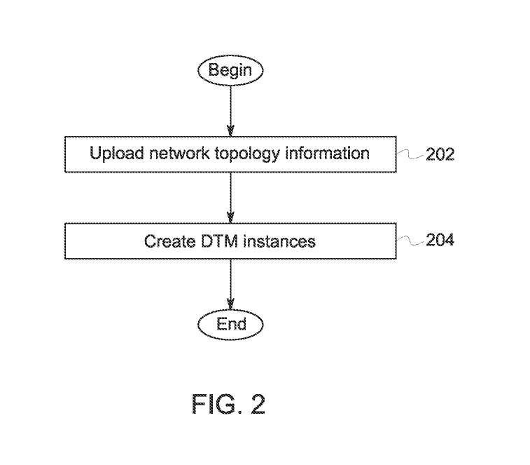

Referring now to FIG. 2, one approach for automatically creating device type manager (DTM)-compliant instances in a Field Device Tool (FDT)-compliant network is described. At step 202, network topology information is uploaded to a user. This may be uploaded from a gateway which has knowledge of the topology. The network topology information concerns a plurality of devices of a known type connected in a network that is located in a predefined local area. The network topology information relates to one or more of an operation of the devices or the interconnection of the plurality of devices in the network. The network may be located, for example at a manufacturing plant, a utility plant, an office building, a campus, or a neighborhood to mention a few examples.

At step 204, at least one DTM-compliant software instance that implements the network topology information is automatically created. For example, a determination may be made if a device DTM module is missing, i.e., whether one of the device DTM modules already in the FDT frame application (and associated with a particular piece of equipment) is missing from the topology. If the device DTM already exists, no new device DTM module need be created. On the other hand, if there is no association, then a new device DTM module is automatically created according to FDT frame application approaches. More specifically, the device's parameters are included in the new module as is functionality (e.g., software instructions) to create messages to obtain or exchange information that is specific to a particular piece of equipment.

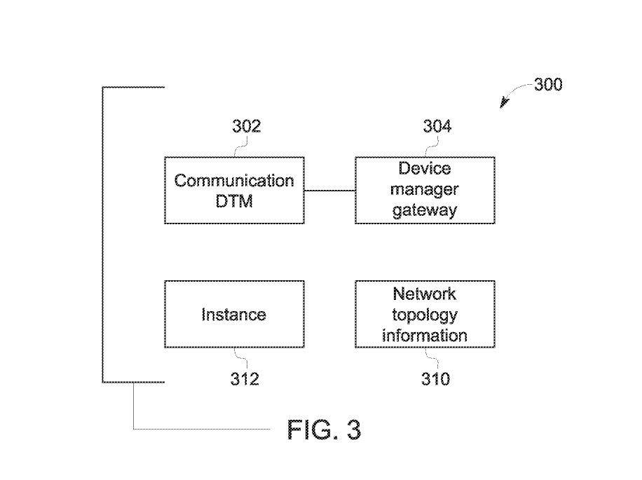

Referring now to FIG. 3, an apparatus 300 that is configured to automatically create device type manager (DTM)-compliant instances in a Field Device Tool (FDT)-compliant network includes an communication DTM 302 and a device manager gateway 304. The communication DTM 302 is configured to receive network topology information 310 from the device manager gateway 304. The network topology information 310 concerns a plurality of devices of a known type connected in a network that is located in a predefined local area. The network topology information 310 relates to one or more of an operation of the devices or an interconnection of the plurality of devices in the network.

The device manager gateway 304 is coupled to the communication DTM 302. The communication DTM 302 is configured to automatically create at least one DTM-compliant software instance 312 that implements the network topology information 310.

Various algorithms may be used to determine whether and how to automatically create the device DTM module. For example, a determination may be made if a device DTM module is missing, i.e., whether one of the device DTM modules already in the FDT frame application (and associated with a particular piece of equipment) is missing from the topology. If the device DTM already exists, no new device DTM module need be created. On the other hand, if there is no association detected, then a new device DTM module is automatically created according to FDT frame application approaches. More specifically, the device's parameters are included in the new module as is functionality (e.g., software instructions) to create messages to obtain or exchange information that is specific to a particular piece of equipment.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method for automatically creating device type manager (DTM)-compliant instances in a Field Device Tool (FDT)-compliant network, the method comprising:
uploading network topology information to a user, the network topology information concerning a plurality of devices of a known type connected in a network that is located in a predefined local area, the network topology information relating to at least one of: an operation of a selected one of the plurality of devices or an interconnection of the plurality of devices in the network; and
automatically creating at least one DTM-compliant software instance that implements the network topology information.

2. The method of claim 1 wherein automatically creating at least one instance comprises allowing the user to select a subset of the topology and then automatically creating at least one DTM-compliant software instance of the selected subset of the network topology information.

3. The method of claim 2 wherein the allowing a user to select comprises allowing the user to select using a graphical display unit.

4. The method of claim 3 wherein the graphical display unit is disposed on a device selected from the group comprising a personal computer, a lap top, a cellular phone and a personal digital assistant.

5. The method of claim 1 wherein the predefined local area comprises a manufacturing plant or a utility plant.

6. The method of claim 1 wherein the uploading is performed by a gateway.

7. The method of claim 1 wherein the plurality of devices comprises a valve or switch.

8. An apparatus that is configured to automatically create device type manager (DTM)-compliant instances in a Field Device Tool (FDT)-compliant network, the apparatus comprising:
a device manager gateway;
an communication DTM coupled to the device manager gateway, the communication DTM being configured to received network topology information from the device manager gateway, the network topology information concerning a plurality of devices of a known type connected in a network that is located in a predefined local area, the network topology information relating to at least one of: an operation of a selected one of the plurality of devices or an interconnection of the plurality of devices in the network, the communication DTM being further configured to automatically create at least one DTM-compliant software instance that implements the network topology information.

9. The apparatus of claim 8 wherein the communication DTM is configured to receive a selection of a subset of the topology and the communication DTM is configured to automatically create at least one DTM-compliant software instance of the selected subset of the network topology information.

10. The apparatus of claim 9 wherein the selection is made at a graphical display unit.

11. The apparatus of claim 10 wherein the graphical display unit is disposed on a device selected from the group comprising a personal computer, a lap top, a cellular phone and a personal digital assistant.

12. The apparatus of claim 8 wherein the predefined local area comprises a manufacturing plant or a utility plant.

13. The apparatus 8 wherein the plurality of devices comprises a valve or switch.
